(19) United States
(12) Patent Application Publication
(10) Pub. No.: US 2022/0291077 A1
(43) Pub. Date: Sep. 15, 2022

(54) DAMAGE DETECTION APPARATUS, DAMAGE DETECTION METHOD, AND COMPUTER-READABLE RECORDING MEDIUM

(71) Applicant: NEC Corporation, Tokyo (JP)

(72) Inventor: Shohei KINOSHITA, Tokyo (JP)

(73) Assignee: NEC Corporation, Tokyo (JP)

(21) Appl. No.: 17/677,090

(22) Filed: Feb. 22, 2022

(30) Foreign Application Priority Data
Mar. 9, 2021 (JP) 2021-037395

(51) Int. Cl. G01M 5/00; G01M 7/02

(52) U.S. Cl. CPC G01M 5/0008; G01M 7/022; G01M 5/0066

(57) ABSTRACT

A damage detection apparatus 10 includes: an extraction unit 11 configured to extract measured mode information representing a mode shape of a structure that is continuously supported at three or more support points, based on a plurality of pieces of vibration information measured by sensors that are disposed at a plurality of locations of the structure; a derivation unit 12 configured to derive reference mode information representing a mode shape serving as a reference for damage evaluation of the structure, using a structure model in which a value representing strength of a coupling rotation spring is set to represent a boundary condition of an intermediate support point of the structure; and a detection unit 13 configured to calculate an index indicating a degree of similarity between the measured mode information and the reference mode information, and detect damage to the structure based on the index indicating the degree of similarity.

### CROSS-REFERENCE TO RELATED APPLICATION

This application is based upon and claims the benefit of priority from Japanese patent application No. 2021-037395, filed on Mar. 9, 2021, the disclosure of which is incorporated herein in its entirety by reference.

### BACKGROUND OF THE INVENTION

### 1. Field of the Invention

The invention relates to a damage detection apparatus, a damage detection method, and a computer-readable recording medium, for detecting damage to a structure.

### 2. Background Art

Techniques for detecting damage to structures have been known as one of the measures against deterioration of social infrastructure structures. As a related art, Japanese Patent Laid-Open Publication No. 2016-125229 (Patent Document 1) discloses a system for estimating the damage state of a structure.

In the system disclosed in Patent Document 1, when a vehicle travels on a structure (bridge), acceleration generated at a predetermined location of the structure is measured by an acceleration sensor disposed at the predetermined location, and actual displacement data is obtained based on acceleration data obtained from the acceleration sensor.

In the system disclosed in Patent Document 1, a vehicle model simulating the vehicle is caused to virtually travel on a structure model simulating the structure in a virtual space, and a virtual displacement occurring at a virtual position of the structure model corresponding to a predetermined location of the structure is obtained as virtual displacement data. Note that a value representing the bending rigidity of concrete is set in the structure model.

In the system disclosed in Patent Document 1, when the actual displacement data and the virtual displacement data are not approximate to each other, the set value of the rigidity in the structure model is repeatedly changed until the virtual displacement data is approximate to the actual displacement data, and thus the value representing the bending rigidity of the structure model is approximated to the bending rigidity of the actual structure.

Furthermore, in the system disclosed in Patent Document 1, the value representing the bending rigidity of the structure model that has been approximated to the bending rigidity of the actual structure is compared with a theoretical value of the bending rigidity of the structure obtained by assuming that predetermined damage has occurred in the structure, and thus it is estimated whether the assumed damage has occurred in the actual structure.

In the system disclosed in Patent Document 1, when the structure is a continuous girder bridge, a large force is likely to be applied to the vicinity of a pier, and therefore damage is concentrated at the vicinity of the pier. For this reason, the value representing the bending rigidity in the vicinity of the pier of the structure model is changed so that a value representing the bending rigidity in the vicinity of the pier is smaller than a value representing the bending rigidity in the vicinity of the center of the bridge, thereby approximating the value representing the bending rigidity in the vicinity of the pier of the structure model to the value representing the bending rigidity of the actual structure.

However, in the system disclosed in Patent Document 1, a value representing the bending rigidity of the structure model that has been approximated to the bending rigidity of the actual structure is compared with a theoretical value obtained by assuming that predetermined damage has occurred in the structure, and thus it is estimated that the assumed damage has occurred in the actual structure.

The dynamic properties of a structure are generally determined based on physical property values (weight and rigidity), geometric properties (shape, dimensions, etc.), and boundary conditions (support conditions and connection conditions). In Patent Document 1, among dynamic properties of a structure, rigidity, which is a physical property value, is focused on.

In Patent Document 1, actual displacement data estimated using acceleration data, and a resonance frequency are used. The actual displacement data is estimated by performing second order numerical integration of acceleration measured while a vehicle is traveling. Accordingly, an integration error is mixed in the actual displacement data due to the vibration characteristics of the vehicle, the selection of an integration interval of acceleration, and the like. For this reason, the accuracy of the estimated actual displacement data is not necessarily high.

In Patent Document 1, a structure (bridge upper structure) is divided into a plurality of elements, simulations are performed a plurality of times while the bending rigidity of the elements is updated, and a value representing the bending rigidity of the structure model is approximated to the bending rigidity of the actual structure. For this reason, it is necessary to perform the simulation a plurality of times.

Also, in Patent Document 1, a theoretical value obtained by assuming that predetermined damage has occurred in a structure is used, and the theoretical value is derived by setting a parameter according to the number of cracks in concrete or broken wires in reinforcing bars. However, because the number of combinations of damage that occurs is innumerable, it is anticipated that it takes time to derive a theoretical value.

### SUMMARY

As one aspect, it is an example object of the invention to provide a damage detection apparatus, a damage detection method, and a computer-readable recording medium that increase the efficiency and accuracy in detecting damage to a structure that is continuously supported at three or more support points.

In order to achieve the above example object, a damage detection apparatus according to an example aspect of the invention includes:

an extraction unit configured to extract measured mode information representing a mode shape of a structure that is continuously supported at three or more support points, based on a plurality of pieces of vibration information measured by sensors that are disposed at a plurality of locations of the structure;

a derivation unit configured to derive reference mode information representing a mode shape serving as a reference for damage evaluation of the structure, using a structure model in which a value representing strength of a coupling rotation spring is set to represent a boundary condition of an intermediate support point of the structure; and a detection unit configured to calculate an index indicating a degree of similarity between the measured mode information and the reference mode information, and detect damage to the structure based on the index indicating the degree of similarity.

In order to achieve the above example object, a damage detection method according to an example aspect of the invention includes:

extracting measured mode information representing a mode shape of a structure that is continuously supported at three or more support points, based on a plurality of pieces of vibration information measured by sensors that are disposed at a plurality of locations of the structure;

deriving reference mode information representing a mode shape serving as a reference for damage evaluation of the structure, using a structure model in which a value representing strength of a coupling rotation spring is set to represent a boundary condition of an intermediate support point of the structure; and

calculating an index indicating a degree of similarity between the measured mode information and the reference mode information, and detecting damage to the structure based on the index indicating the degree of similarity.

In order to achieve the above example object, a computer-readable recording medium according to an example aspect of the invention causes a computer to:

extract measured mode information representing a mode shape of a structure that is continuously supported at three or more support points, based on a plurality of pieces of vibration information measured by sensors that are disposed at a plurality of locations of the structure;

derive reference mode information representing a mode shape serving as a reference for damage evaluation of the structure, using a structure model in which a value representing strength of a coupling rotation spring is set to represent a boundary condition of an intermediate support point of the structure; and

calculate an index indicating a degree of similarity between the measured mode information and the reference mode information, and detect damage to the structure based on the index indicating the degree of similarity.

As one aspect, the invention can increase the efficiency and accuracy in detecting damage to a structure that is continuously supported at three or more support points.

### BRIEF DESCRIPTION OF THE DRAWINGS

FIG. 1 is a diagram illustrating an example of a damage detection apparatus.

FIG. 2 is a diagram illustrating an example of a structure.

FIG. 3 is a diagram illustrating how a mode shape is extracted.

FIG. 4 is a diagram illustrating an example of a structure model.

FIG. 5 is a diagram illustrating the relationship between a measured mode shape, a reference mode shape, and a MAC.

FIG. 6 is a diagram illustrating an example of a system including the damage detection apparatus.

FIG. 7 is a diagram illustrating how the damage detection apparatus operates.

FIG. 8 is a diagram illustrating how the reference mode shape is derived.

FIG. 9 is a diagram illustrating an example of a computer that realizes the damage detection apparatus.

### EXEMPLARY EMBODIMENTS

### Example Embodiment

Hereinafter, an example embodiment will be described with reference to the drawings. In the drawings described below, elements having the same functions or corresponding functions are denoted by the same reference numerals, and repeated description thereof may be omitted.

### Apparatus Configuration

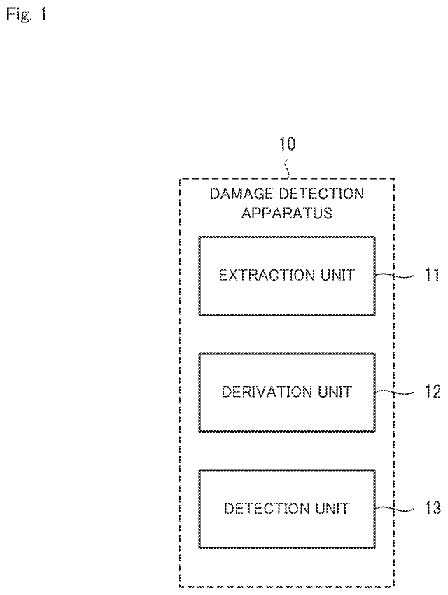

A configuration of a damage detection apparatus according to an example embodiment will be described with reference to FIG. 1. FIG. 1 is a diagram illustrating an example of the damage detection apparatus.

A damage detection apparatus 10 illustrated in FIG. 1 has a function of accurately detecting damage to a structure that is continuously supported at three or more support points. The damage detection apparatus 10 includes an extraction unit 11, a derivation unit 12, and a detection unit 13.

Next, the structure will be described.

As the structure that is continuously supported at three or more support points, for example, a floor slab serving as a member constituting a multi-span continuous bridge can be considered. However, the structure is not limited to a floor slab. Note that a multi-span continuous bridge includes a building such as a bridge and a viaduct.

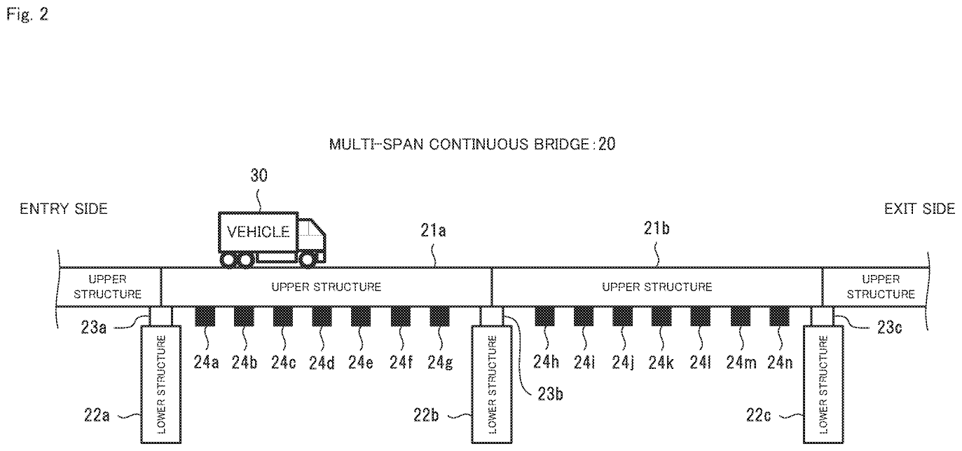

FIG. 2 is a diagram illustrating an example of the structure. In the example illustrated in FIG. 2, an upper structure 21a is supported by a lower structure 22a and a support portion 23a, and a lower structure 22b and a support portion 23b. An upper structure 21b is supported by the lower structure 22b and the support portion 23b, and a lower structure 22c and a support portion 23c.

The upper structures 21a and 21b each have a floor structure and a main structure. The floor structures are formed by floor slabs, floor sets, and the like. The main structures have main girders and the like, support the floor structures, and transmit loads to the lower structures 22a, 22b, and 22c.

The lower structures 22a, 22b, and 22c include: abutments that are provided at both ends of the bridge and that support the upper structures 21a and 21b and transmit loads to the ground; piers that are provided in the middle of the bridge; and foundations that support the abutments and the piers.

The support portions 23a, 23b, and 23c are installed between the upper structures 21a and 21b and the lower structures 22a, 22b, and 22c. The support portions 23 transmit loads applied to the upper structures 21 to the lower structures 22.

Sensors 24 (24a to 24n) are attached to the upper structures 21a and 21b, and measure at least the magnitude of vibration of the upper structures 21a and 21b.

In the example illustrated in FIG. 2, a vehicle 30 travels from an entry side to an exit side on the upper structures 21a and 21b.

Next, the damage detection apparatus will be described.

The extraction unit 11 extracts measured mode information representing a mode shape of a structure that is continuously supported at three or more support points, based on a plurality of pieces of vibration information measured by the sensors disposed at a plurality of locations of the structure.

The mode shape of a structure represents a vibration state of the structure by a shape, for each natural frequency (natural resonance frequency) of the structure.

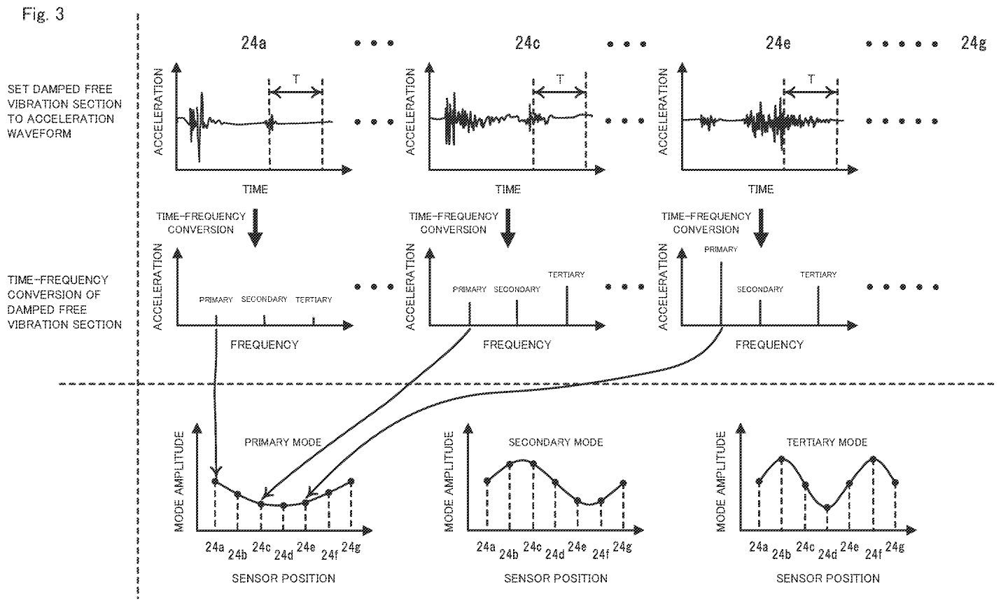

FIG. 3 is a diagram illustrating how the mode shape is extracted. FIG. 3 illustrates an example of extracting the mode shape of the upper structure 20a.

Specifically, first, the extraction unit 11 obtains a plurality of pieces of vibration information measured by the respective sensors 24a to 24g, and sets a damped free vibration section for each vibration waveform represented by the obtained vibration information. In the example illustrated in FIG. 3, the damped free vibration section T is set to respective vibration waveforms represented by the vibration information measured by the sensors 24a to 24g.

Note that, in the example illustrated in FIG. 3, vibration waveforms represented by the vibration information measured by the sensors 24b, 24d, 24f, and 24g are not illustrated for convenience.

Next, the extraction unit 11 performs time-frequency conversion on the vibration waveform included in the damped free vibration section T that has been set for each of the sensors 24a to 24g. In the example illustrated in FIG. 3, it is shown that primary, secondary, and tertiary natural frequencies and amplitudes for each of the natural frequencies have been obtained for each of the sensors 24a to 24g.

Note that, in the example illustrated in FIG. 3, natural frequencies for the sensors 24b, 24d, 24f, and 24g are not illustrated for convenience. In the example illustrated in FIG. 3, natural frequencies up to the third order are shown, but natural frequencies equal to or greater than the third order may also be used.

Next, the extraction unit 11 generates mode shapes for respective natural frequencies. In the example shown in FIG. 3, the primary mode is generated by associating the mode amplitudes generated based on the acceleration corresponding to the respective primary natural frequencies of the sensors 24a to 24g with the locations of the sensors 24a to 24g on the upper structure 21a.

Similarly to the primary mode, the secondary mode and the tertiary mode may be generated by generating secondary and tertiary mode amplitudes and relating these amplitudes to the locations of the corresponding sensors 24a to 24g on the upper structure 21a.

The mode shapes are generated for the upper structure 21b in the same manner as the upper structure 21a.

The derivation unit 12 derives reference mode information representing a mode shape serving as a reference for damage evaluation of the structure, using a structure model in which a value representing strength of a coupling rotation spring is set to represent a boundary condition of an intermediate support point of the structure.

The structure model is a model for deriving vibration at any point in a structure that is continuously supported at three or more support points.

The structure model is represented using coordinate functions used to represent the amplitudes of the positions of the sensors 24 that are disposed at a plurality of locations of the structure, a boundary condition of the intermediate support point, and boundary conditions of both end support points set for both end support points of the structure.

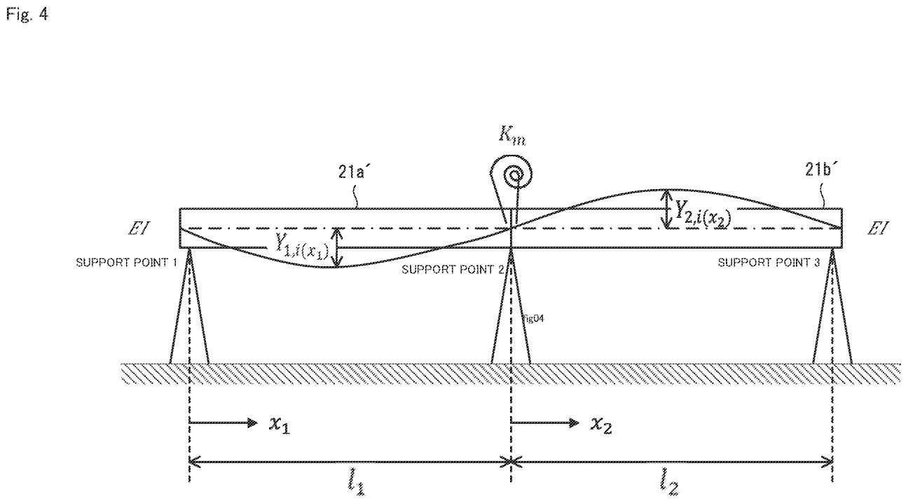

The structure model illustrated in FIG. 4 is, for example, a model simulating a multi-span continuous bridge. FIG. 4 is a diagram illustrating an example of the structure model.

In the model illustrated in FIG. 4, the upper structure 21a of the multi-span continuous bridge illustrated in FIG. 2 is defined as a structure 21a′, and the upper structure 21b is defined as a structure 21b′. In addition, the position of the support portion 23a is defined as a support point 1, the position of the support portion 23b is defined as a support point 2, and the position of the support portion 23c is defined as a support point 3.

Points are freely set at distances corresponding to the positions of the sensors 24a to 24n. In the example illustrated in FIG. 4, the positions of the sensors 24a to 24n can be represented using a distance x₁ from the support point 1 and a distance x₂ from the support point 2.

Furthermore, the vibration at freely-set points x₁ and x₂ of the respective structures 21a′ and 21b′ can be represented using a coordinate function. Formula 1 represents a coordinate function Y_{1,i}(x₁) of the structure 21a′.

$${Y}_{1 , i} ( {x}_{1} ) = {C}_{1 , i , 1} sin ( {k}_{i} {x}_{1} ) + {C}_{1 , i , 2} cos ( {k}_{i} {x}_{1} ) + {C}_{1 , i , 3} sinh ( {k}_{i} {x}_{1} ) + {C}_{1 , i , 4} cosh ( {k}_{i} {x}_{1} ) \qquad Formula 1$$

Y_{1,i}(x₁): Coordinate function representing vibration at a freely-set point x1 of the structure 20a C_{1,i,1}, C_{1,i,2}, C_{1,i,3}, C_{1,i,4}: Coefficients (integral constants) determined by boundary conditions ki: Eigenvalue in i-th mode

Formula 2 represents a coordinate function Y_{2,i}(x₂) of the structure 21b′.

$${Y}_{2 , i} ( {x}_{2} ) = {C}_{2 , i , 1} sin ( {k}_{i} {x}_{2} ) + {C}_{2 , i , 2} cos ( {k}_{i} {x}_{2} ) + {C}_{2 , i , 3} sinh ( {k}_{i} {x}_{1} ) + {C}_{2 , i , 4} cosh ( {k}_{i} {x}_{1} ) \qquad Formula 2$$

Y_{2,i}(x₂): Coordinate function representing vibration at a freely-set point x2 of the structure 20b C_{2,i,1}, C_{2,i,2}, C_{2,i,3}, C_{2,i,4}: Coefficients (integral constants) determined by boundary conditions kᵢ: Eigenvalue in i-th mode

Formula 3 represents a boundary condition of one end portion, which is an end portion on the support point 1 side, of the structure 21a′.

$${Y}_{1 , i} ( {x}_{1} = 0 ) = 0 \\ ( \frac{{d}^{2} {Y}_{1 , i}}{{dx}_{1}^{2}} ) = 0 \qquad Formula 3$$

Formula 4 represents a boundary condition of one end portion, which is an end portion on the support point 3 side, of the structure 21b′.

$${Y}_{2 , i} ( {x}_{2} = {l}_{2} ) = 0 \\ {( \frac{{d}^{2} {Y}_{2 , i}}{{dx}_{2}^{2}} )}_{{x}_{2} = {l}_{2}} \qquad Formula 4$$

l₂: Inter-support-point distance [m] between the support point 2 and the support point 3

Formula 5 represents a boundary condition of another end portion, that is an end portion on the intermediate support point 2 side, of the structures 21a′ and 21b′.

$${Y}_{1 , i} ( {x}_{1} = {l}_{1} ) = 0 \\ {Y}_{2 , i} ( {x}_{2} = 0 ) = 0 \\ - {( \frac{{d}^{2} {Y}_{1 , i}}{{dx}_{1}^{2}} )}_{{x}_{1} = {l}_{1}} = - {( \frac{{d}^{2} {Y}_{2 , i}}{{dx}_{2}^{2}} )}_{{x}_{2} = 0} = R \{ {( \frac{{dY}_{1 , i}}{{dx}_{1}} )}_{{x}_{1} = {l}_{1}} - {( \frac{{dY}_{2 , i}}{{dx}_{2}} )}_{{x}_{2} = 0} \} \qquad Formula 5$$

Formula 6 represents the coupling rotation spring strength index.

$$R = ( \frac{{K}_{m}}{EI} ) \qquad Formula 6$$

Kₘ: Rotation spring constant
EI: Bending rigidity

When deriving the mode shapes using the structure model of the multi-span continuous bridge 20 illustrated in FIG. 2, the derivation unit 12 derives the amplitudes of the positions corresponding to the sensors 24 by applying the distances between the support points of the structure and the value representing the strength of the coupling rotation spring to the structure model.

Specifically, first, the derivation unit 12 substitutes, into the coordinate functions and the boundary conditions shown in Formulas 3 to 6, the inter-support-point distance l1, the inter-support-point distance l2, the positions of the sensors 24a to 24n, the rotation spring constant Km, and the bending rigidity EI that is set in advance.

The distance between the support points of the upper structure 21a is substituted into the inter-support-point distance l1. The distance between the support points of the upper structure 21b is substituted into the inter-support-point distance l2. The rotation spring constant Km and the bending rigidity EI are determined by experiment or simulation.

Next, the derivation unit 12 generates a coefficient matrix to solve simultaneous equations related to the coefficients C_{1,i,1}, C_{1,i,2}, C_{1,i,3}, C_{1,i,4}, C_{2,i,1}, C_{2,i,2}, C_{2,i,3}, C_{2,i,4} of the coordinate functions Y_{1,i}(x₁), Y_{2,i}(x₂). Then, the derivation unit 12 determines an eigenvalue kᵢ according to which the generated coefficient matrix becomes zero.

Then, the derivation unit 12 calculates the coefficients C_{1,i,1}, C_{1,i,2}, C_{1,i,3}, C_{1,i,4}, C_{2,i,1}, C_{2,i,2}, C_{2,i,3}, and C_{2,i,4}. Thereafter, the derivation unit 12 substitutes, into the coordinate functions Y_{1,i}(x₁), Y_{2,i}(x₂), the calculated coefficients C_{1,i,1}, C_{1,i,2}, C_{1,i,3}, C_{1,i,4}, C_{2,i,1}, C_{2,i,2}, C_{2,i,3}, and C_{2,i,4}.

Next, the derivation unit 12 calculates amplitudes at the positions of the respective sensors 24a to 24n. Then, the derivation unit 12 derives mode shapes serving as references for evaluating damage to the structure, using the positions of the respective sensors 24a to 24n and the calculated amplitudes

The detection unit 13 calculates an index indicating a degree of similarity between the measured mode information and the reference mode information, and detects damage to the structure based on the index indicating the degree of similarity.

As an index indicating a degree of similarity, for example, a modal assurance criterion (MAC) or the like is used. A MAC is represented by Formula 7.

$$MAC ( F , I ) = \frac{{‖ {ϕ}_{F}^{T} {ϕ}_{I} ‖}^{2}}{{‖ {ϕ}_{F} ‖}^{2} {‖ {ϕ}_{I} ‖}^{2}} \\ {ϕ}_{F} {=}^{t} ( {r}_{1}^{F} {e}^{i {θ}_{1}^{F}} , {r}_{2}^{F} {e}^{i {θ}_{2}^{F}} , … , {r}_{n}^{F} {e}^{i {θ}_{n}^{F}} ) \\ {ϕ}_{I} {=}^{t} ( {r}_{1}^{I} {e}^{i {θ}_{1}^{I}} , {r}_{2}^{I} {e}^{i {θ}_{2}^{I}} , … , {r}_{n}^{I} {e}^{i {θ}_{n}^{I}} ) \qquad Formula 7$$

MAC(F, I): Modal assurance criterion (value representing correlation between mode vectors)
Φ_{F}: Mode vector representing a measured mode shape
Φ_{I}: Mode vector representing a reference mode shape
rₙ: Amplitude at the sensor position
θₙ: Phase at the sensor position
n: Value for identifying sensors (n is an integer larger than or equal to 1, and corresponds to the number of sensors (sensors 24a to 24n))

Specifically, the detection unit 13 converts the measured mode shape extracted by the extraction unit 11 into a mode vector, and then, converts the reference mode shape derived by the derivation unit 12 into a mode vector. Next, the detection unit 13 calculates a MAC using the mode vector Φ_{F} obtained by converting the measured mode shape, and the mode vector Φ_{I} obtained by converting the reference mode shape.

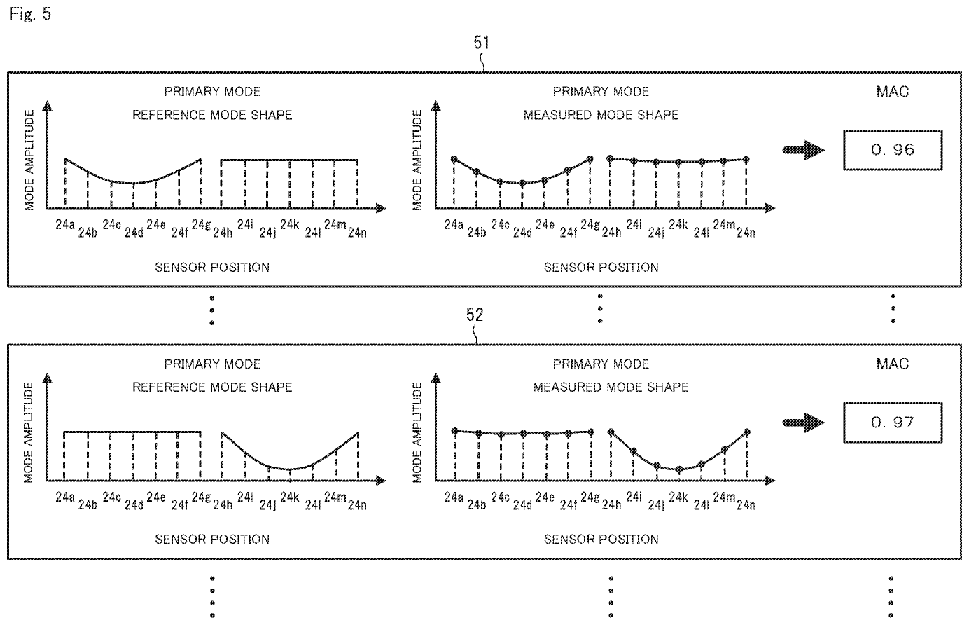

A MAC is represented by a value between 0 and 1, and the closer to 1 the MAC is, the higher the degree of similarity is. FIG. 5 is a diagram illustrating the relationship between the measured mode shape, the reference mode shape, and a MAC.

In the example illustrated in FIG. 5, a MAC is calculated using a measured mode shape of the extracted primary mode obtained by causing the predetermined vehicle 30 to travel on the upper structures 21a and 21b, and a reference mode shape derived by virtually causing the vehicle 30 to travel on the structure models 21a′ and 21b′.

In 51 and 52 illustrated in FIG. 5, because the respective measured mode shapes and reference mode shapes are similar to each other, MACs show high values of 0.96 and 0.97.

Therefore, when damage to the upper structures 21a and 21b of the multi-span continuous bridge 20 progresses, the measured mode shape changes from a normal state (a state in which the structure is not damaged), and the MAC decreases when the measured mode shape is compared with the reference mode shape representing the normal state, and thereby damage to the upper structures 21a and 21b can be detected.

In the example illustrated in FIG. 5, the primary mode has been described, but damage can be detected by calculating a MAC in the same manner for the secondary mode and the tertiary mode.

Also, in the example embodiment, dynamic characteristics of a structure having a complicated support structure such as a multi-span continuous bridge are also simulated by focusing on a boundary condition of an intermediate support point of the structure, thus accuracy of detecting damage is increased.

In addition, in the example embodiment, the measured mode shape is extracted by directly using the vibration information (for example, acceleration) obtained from the sensors, thus the degree of similarity between the measured mode shape and the reference mode shape can be calculated with a small error.

Furthermore, in the example embodiment, the reference mode shape is efficiently derived through a simple process, without deriving the structure model through a complicated simulation.

As described above, in the example embodiment, because the comparison is performed using a MAC using a measured mode shape and a reference mode shape, it is possible to increase efficiency and accuracy in detecting damage to a structure that is continuously supported at three or more support points.

### System Configuration

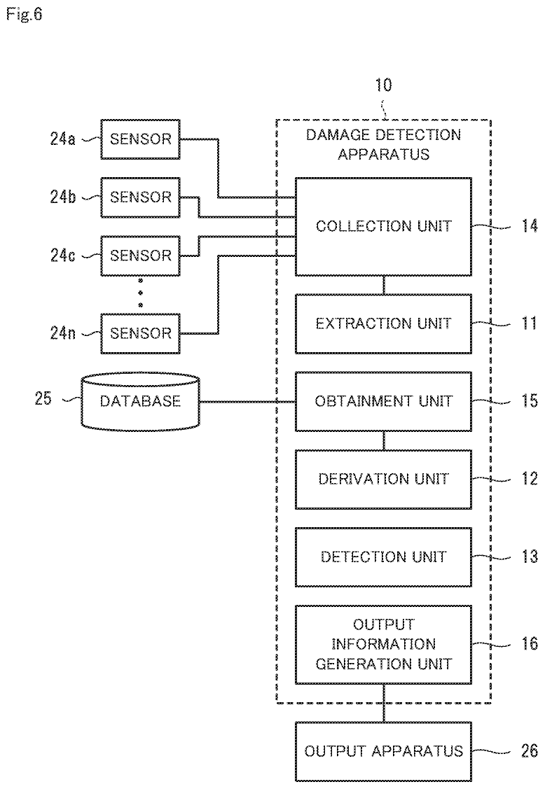

The configuration of the damage detection apparatus 10 according to the example embodiment will be described more specifically. FIG. 6 is a diagram illustrating an example of a system including the damage detection apparatus. As illustrated in FIG. 6, the system according to the example embodiment includes the damage detection apparatus 10, sensors 24, a database 25, and an output apparatus 26.

Next, the system will be described.

The sensors 24 are attached to the floor slabs, measure at least the magnitude of vibration of the floor slabs, and transmit signals each having vibration information indicating the measured magnitude of vibration to the damage detection apparatus 10. As the sensors 24, for example, triaxial acceleration sensors, fiber sensors, or the like can be used.

Specifically, as illustrated in FIG. 2, the vehicle 30 is caused to travel on the upper structures 21a and 21b. Then, the plurality of sensors 24 attached to the floor slabs (structures) of the upper structures 21 measure acceleration at the respective attached positions. Each of the sensors 24 transmits, to the damage detection apparatus 10, a signal having vibration information indicating the measured acceleration.

Wired communication or wireless communication is used for communication between the sensors 24 and the damage detection apparatus 10. The vibration information is, for example, information in which an acceleration and a date and time when the acceleration is measured are associated with each other. Note that the vibration information may also be information representing displacement or information representing velocity.

The database 25 is a storage device that stores information on a structure that is continuously supported at three or more support points. In the example illustrated in FIG. 6, the database 25 is provided outside the damage detection apparatus 10, but the database 25 may also be provided inside the damage detection apparatus 10.

The information on the structure is data necessary for deriving at least a structure model.

The output apparatus 26 obtains output information converted by an output information generation unit 16 into a format that can be output, and generates and outputs an image, sound, and the like, based on the output information. The output apparatus 26 is, for example, an image display apparatus including a liquid crystal display, an organic electro luminescence (EL) display, or a cathode ray tube (CRT). The image display apparatus may include an audio output apparatus such as a speaker. Also, the output apparatus 26 may be a printing apparatus such as a printer.

Next, the damage detection apparatus will be specifically described.

The damage detection apparatus 10 includes a collection unit 14, an extraction unit 11, an obtainment unit 15, a derivation unit 12, a detection unit 13, and an output information generation unit 16.

The damage detection apparatus 10 is, for example, an information processing apparatus, such as a circuit, a server computer, a personal computer, or a mobile terminal, including a programmable device such as a central processing unit (CPU) or a field-programmable gate array (FPGA), a graphics processing unit (GPA), or one or more of these devices.

The collection unit 14 collects a plurality of pieces of vibration information transmitted through wired communication, wireless communication, or the like from the plurality of sensors 24 attached to the floor slabs of the upper structures 21. Thereafter, the collection unit 14 outputs, to the extraction unit 11, the plurality of pieces of collected vibration information.

First, the extraction unit 11 obtains, from the collection unit 14, a plurality of pieces of vibration information indicating acceleration measured by the sensors 24. Next, the extraction unit 11 determines whether or not the acceleration measured by each of the sensors 24 exceeds a threshold Th.

Then, if acceleration exceeds the threshold Th, the extraction unit 11 sets, as a damped free vibration section T, a section included in a time from a time point (start date and time ts) at which the acceleration exceeds the threshold Th to a time point (end date and time te) at which a predetermined time elapses. Then, the extraction unit 11 sets the damped free vibration section T also for the vibration waveform measured by each of the sensors 24a to 24n.

Next, the extraction unit 11 performs time-frequency conversion on the vibration waveform included in the damped free vibration section T that has been set for each of the sensors 24a to 24g. Next, the extraction unit 11 generates measured mode shapes for respective natural frequencies (see FIG. 3).

To extract the measured mode shapes, for example, a frequency-domain decomposition method (FDD method), a stochastic subspace method (SSI method), an eigen-realization algorithm (ERA), a Bayesian estimation method (BAYOMA), or the like may be used.

The obtainment unit 15 obtains, from the database 25, information related to a structure to be inspected that is continuously supported at three or more support points. Thereafter, the obtainment unit 15 outputs the obtained information to the derivation unit 12.

First, the derivation unit 12 obtains, from the obtainment unit 15, information on a structure that is continuously supported at three or more support points. Next, the derivation unit 12 substitutes the inter-support-point distance l1, the inter-support-point distance l2, the positions of sensors 24a to 24n, and the rotation spring constant Km and the bending rigidity EI that have been set in advance, into the coordinate functions and the boundary conditions shown in Formulas 3 to 6.

Then, the derivation unit 12 generates a coefficient matrix to solve the simultaneous equations related to coefficients C_{1,i,1}, C_{1,i,2}, C_{1,i,3}, C_{1,i,4}, C_{2,i,1}, C_{2,i,2}, C_{2,i,3}, and C_{2,i,4} of the coordinate functions Y_{1,i}(x₁), Y_{2,i}(x₂), and determines an eigenvalue kᵢ according to which the coefficient matrix becomes zero.

Then, the derivation unit 12 calculates the coefficients C_{1,i,1}, C_{1,i,2}, C_{1,i,3}, C_{1,i,4}, C_{2,i,1}, C_{2,i,2}, C_{2,i,3}, and C_{2,i,4}, and substitutes the calculated C_{1,i,1}, C_{1,i,2}, C_{1,i,3}, C_{1,i,4}, C_{2,i,1}, C_{2,i,2}, C_{2,i,3}, and C_{2,i,4} into the coordinate functions Y_{1,i}(x₁), Y_{2,i}(x₂).

Next, the derivation unit 12 calculates amplitudes for the respective positions of the sensors 24a to 24n, and derives a mode shape serving as a reference for evaluating damage to the structure, using the respective positions of the sensors 24a to 24n and the calculated amplitudes.

First, the detection unit 13 converts the measured mode shape extracted by the extraction unit 11 and the reference mode shape derived by the derivation unit 12 into mode vectors. Next, the detection unit 13 calculates a MAC representing a correlation between the mode vector Φ_{F} obtained by converting the measured mode shape and the mode vector Φ_{I} obtained by converting the reference mode shape.

The detection unit 13 determines whether or not the structure is damaged based on the calculated index indicating the degree of similarity. When the MAC is smaller than a preset threshold value, for example, the detection unit 13 determines that the structure is damaged.

When damage to the upper structures 21a and 21b of the multi-span continuous bridge 20 progresses, for example, the measured mode shape changes from a normal state (a state in which the structure is not damaged), and therefore the MAC decreases when the measured mode shape is compared with the reference mode shape representing the normal state. In this manner, damage to the upper structures 21a and 21b can be detected.

The output information generation unit 16 generates output information for causing the output apparatus 26 to output whether or not the structure is damaged, and outputs the generated output information to the output apparatus 26. Thereafter, the output apparatus 26 outputs whether or not the structure is damaged, based on the output information. Note that the output apparatus 26 may display not only the result indicating whether the structure is damaged, but also, for example, the measured mode shape, the reference mode shape, the MAC, and the like.

### Apparatus Operation

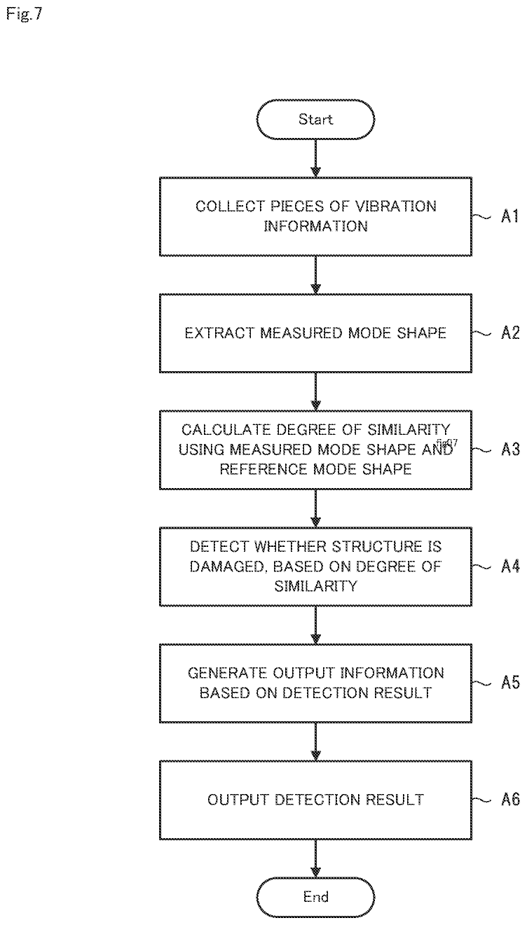

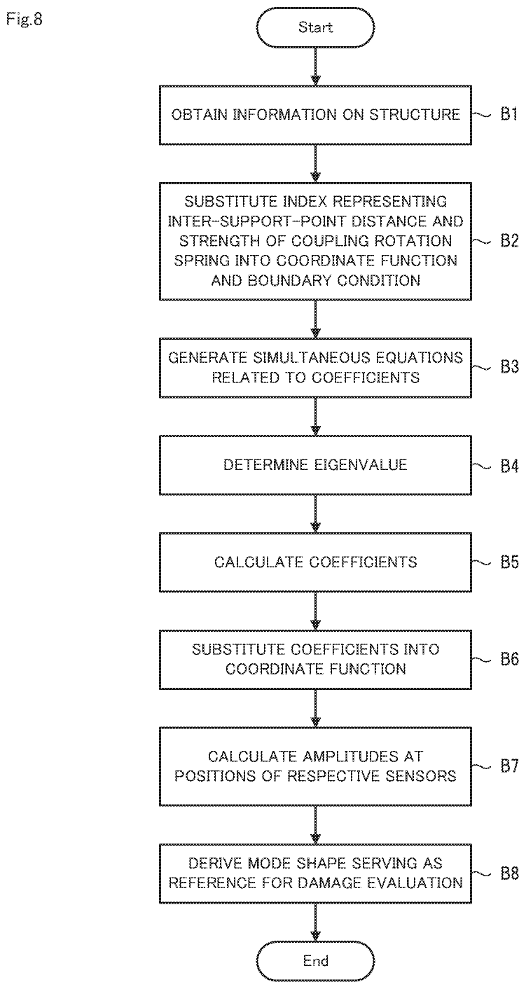

Next, an operation of the damage detection apparatus according to the example embodiment will be described with reference to FIGS. 7 and 8. FIG. 7 is a diagram illustrating how the damage detection apparatus operates. FIG. 8 is a diagram illustrating how the reference mode shape is derived. In the following description, the drawings are referred to as appropriate. In the example embodiment, the damage detection method is performed by operating the damage detection apparatus. For this reason, the following description of the operation of the damage detection apparatus also includes the description of the damage detection method according to the example embodiment.

The operation of the damage detection apparatus will be described below.

First, the collection unit 14 collects a plurality of pieces of vibration information transmitted, through wired communication, wireless communication, or the like, from the plurality of sensors 24 attached to the floor slabs of the upper structures 21 (step A1). Thereafter, the collection unit 14 outputs, to the extraction unit 11, the plurality of pieces of collected vibration information.

Next, the extraction unit 11 extracts measured mode information representing a mode shape of a structure that is continuously supported at three or more support points, based on vibration information measured by the sensors disposed at a plurality of locations of the structure (step A2).

Then, the detection unit 13 calculates an index indicating a degree of similarity between the measured mode information and the reference mode information (step A3), and detects whether the structure is damaged, based on the index indicating the degree of similarity (step A4).

The reference mode information may be generated in advance by the derivation unit 12, or may also be generated when the damage detection is performed. The operation of the derivation unit 12 will be described later (see FIG. 8).

Next, the output information generation unit 16 generates output information for causing the output apparatus 26 to output whether or not the structure is damaged, and outputs the generated output information to the output apparatus 26 (step A5). Then, the output apparatus 26 outputs whether or not the structure is damaged, based on the output information (step A6). Note that the output apparatus 26 may display not only the result indicating whether the structure is damaged, but also, for example, the measured mode shape, the reference mode shape, the MAC, and the like.

Next, the operation of deriving the reference mode shape will be described.

First, the derivation unit 12 obtains, from the obtainment unit 15, information on the structure that is continuously supported at three or more support points (step B1).

Next, the derivation unit 12 substitutes the inter-support-point distance l1, the inter-support-point distance l2, the positions of sensors 24a to 24n, and the rotation spring constant Km and the bending rigidity EI that have been set in advance, into the coordinate functions and the boundary conditions shown in Formulas 3 to 6 (step B2).

Next, the derivation unit 12 generates simultaneous equations (coefficient matrix) related to the coefficients C_{1,i,1}, C_{1,i,2}, C_{1,i,3}, C_{1,i,4}, C_{2,i,1}, C_{2,i,2}, C_{2,i,3}, and C_{2,i,4} of the coordinate functions Y_{1,i}(x₁), Y_{2,i}(x₂) (step B3), and determines an eigenvalue k according to which the coefficient matrix becomes zero (step B4).

Then, the derivation unit 12 calculates the coefficients C_{1,i,1}, C_{1,i,2}, C_{1,i,3}, C_{1,i,4}, C_{2,i,1}, C_{2,i,2}, C_{2,i,3}, and C_{2,i,4} (step B5), and substitutes the calculated coefficients C_{1,i,1}, C_{1,i,2}, C_{1,i,3}, C_{1,i,4}, C_{2,i,1}, C_{2,i,2}, C_{2,i,3}, and C_{2,i,4} into the coordinate functions Y_{1,i}(x₁), Y_{2,i}(x₂) (step B6).

Next, the derivation unit 12 calculates amplitudes for the respective positions of the sensors 24a to 24n (step B7), and derives a mode shape serving as a reference for evaluating damage to the structure, using the respective positions of the sensors 24a to 24n and the calculated amplitudes (step B8).

### Effects of Example Embodiment

As described above, according to the example embodiment, the measured mode shape and the reference mode shape are compared with each other using a MAC, and therefore it is possible to increase efficiency and accuracy in detecting damage to a structure that is continuously supported at three or more support points.

Also, when damage to the upper structures 21a and 21b of the multi-span continuous bridge 20 progresses, the measured mode shape changes from a normal state (a state in which the structure is not damaged), and the MAC decreases when the measured mode shape is compared with the reference mode shape representing the normal state, and therefore damage to the upper structures 21a and 21b can be detected.

Also, in the example embodiment, dynamic characteristics of a structure having a complicated support structure such as a multi-span continuous bridge are also simulated by focusing on boundary conditions of an intermediate support point of the structure, and therefore accuracy of detecting damage is increased.

In addition, in the example embodiment, the measured mode shape is extracted by directly using the vibration information (for example, acceleration) obtained from the sensors, thus the degree of similarity between the measured mode shape and the reference mode shape can be calculated with a small error.

Furthermore, in the example embodiment, the reference mode shape is efficiently derived through a simple process, without deriving the structure model through a complicated simulation.

### Program

The program according to the example embodiment of the invention may be a program that causes a computer to execute steps A1 to A6 shown in FIG. 7, and steps B1 to B8 shown in FIG. 8. Installing this program in a computer and executing the program makes it possible to realize the damage detection apparatus and the damage detection method according to the example embodiment. In this case, the processor of the computer functions as the collection unit 14, the extraction unit 11, the obtainment unit 15, the derivation unit 12, the detection unit 13, and the output information generation unit 16, and performs processing.

Note that the program according to the example embodiment may also be executed by a computer system constructed by a plurality of computers. In this case, each of the computers may function as any of the collection unit 14, the extraction unit 11, the obtainment unit 15, the derivation unit 12, the detection unit 13, and the output information generation unit 16.

### Physical Configuration

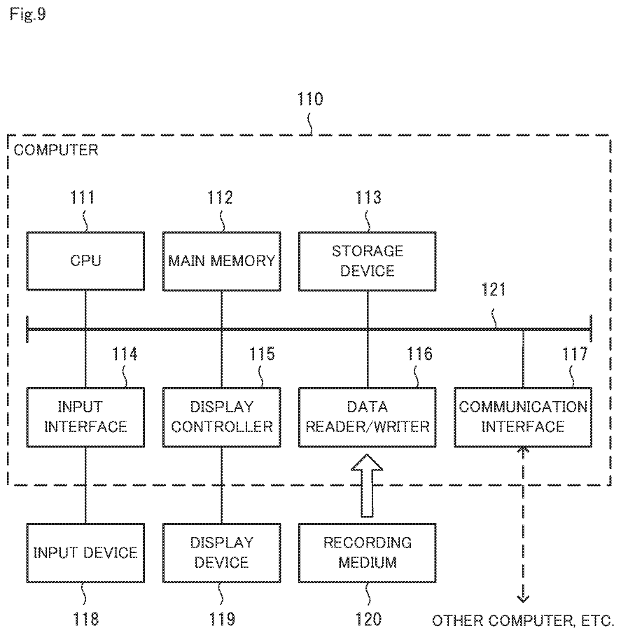

Next, a computer that realizes the damage detection apparatus by executing the program according to the example embodiment will be described with reference to FIG. 9. FIG. 9 is a diagram illustrating an example of a computer that realizes the damage detection apparatus.

As illustrated in FIG. 9, a computer 110 includes a central processing unit (CPU) 111, a main memory 112, a storage device 113, an input interface 114, a display controller 115, a data reader/writer 116, and a communication interface 117. These components are connected to each other via a bus 121 to be capable of data communication. Note that the computer 110 may include a GPU or an FPGA, in addition to or instead of the CPU 111.

The CPU 111 loads a program (code) according to the example embodiment stored in the storage device 113 into the main memory 112, and executes the program in a predetermined order, thereby performing various operations. The main memory 112 is typically a volatile storage device, such as a dynamic random access memory (DRAM). Furthermore, the program according to the example embodiment is stored in a computer-readable recording medium 120 to be provided. The program according to the example embodiment may be distributed on the Internet connected via the communication interface 117. Note that the recording medium 120 is a non-volatile recording medium.

Specific examples of the storage device 113 include a semiconductor storage device such as a flash memory, in addition to a hard disk drive. The input interface 114 transmits and receives data between the CPU 111 and an input device 118 such as a keyboard and a mouse. The display controller 115 is connected to a display apparatus 119, and controls display on the display apparatus 119.

The data reader/writer 116 transmits and receives data between the CPU 111 and the recording medium 120, and executes reading of a program from the recording medium 120 and writing of a processing result in the computer 110 to the recording medium 120. The communication interface 117 transmits and receives data between the CPU 111 and other computers.

Specific examples of the recording medium 120 include a general-purpose semiconductor storage device such as a compact flash (CF) (registered trademark) and a secure digital (SD), a magnetic recording medium such as a flexible disk, and an optical recording medium such as a compact disk read only memory (CD-ROM).

The damage detection apparatus 10 according to the example embodiment can also be achieved using hardware corresponding to the components, instead of a computer in which a program is installed. Furthermore, a part of the damage detection apparatus 10 may be realized by a program and the remaining part may be realized by hardware.

### Supplementary Notes

With respect to the above example embodiment, the following supplementary notes are further disclosed. Some or all of the above example embodiment can be expressed by (Supplementary note 1) to (Supplementary note 18) described below, but the invention is not limited to the following description.

### (Supplementary Note 1)

A damage detection apparatus including:

an extraction unit configured to extract measured mode information representing a mode shape of a structure that is continuously supported at three or more support points, based on a plurality of pieces of vibration information measured by sensors that are disposed at a plurality of locations of the structure;

a derivation unit configured to derive reference mode information representing a mode shape serving as a reference for damage evaluation of the structure, using a structure model in which a value representing strength of a coupling rotation spring is set to represent a boundary condition of an intermediate support point of the structure; and

a detection unit configured to calculate an index indicating a degree of similarity between the measured mode information and the reference mode information, and detect damage to the structure based on the index indicating the degree of similarity.

### (Supplementary Note 2)

The damage detection apparatus according to supplementary note 1,

wherein the structure model is represented using: coordinate functions that are used for representing amplitudes at positions corresponding to the sensors disposed at a plurality of locations of the structure; a boundary condition of the intermediate support point; and boundary conditions of both end support points respectively set at both end support points of the structure.

### (Supplementary Note 3)

The damage detection apparatus according to supplementary note 1 or 2,

wherein the derivation unit derives the amplitudes at the positions corresponding to the sensors, by applying, to the structure model, distances between support points of the structure, and a value representing strength of the coupling rotation spring.

### (Supplementary Note 4)

The damage detection apparatus according to any one of supplementary notes 1 to 3,

wherein the vibration information is information representing displacement, information representing velocity, or information representing acceleration.

### (Supplementary Note 5)

The damage detection apparatus according to any one of supplementary notes 1 to 4,

wherein the detection unit calculates the index representing the degree of similarity, using a modal assurance criterion representing a correlation between the measured mode information and the reference mode information.

### (Supplementary Note 6)

The damage detection apparatus according to any one of supplementary notes 1 to 5,

wherein the structure is a floor slab of a multi-span continuous bridge.

### (Supplementary Note 7)

A damage detection method including:

(a) a step of a computer extracting measured mode information representing a mode shape of a structure that is continuously supported at three or more support points, based on a plurality of pieces of vibration information measured by sensors that are disposed at a plurality of locations of the structure;

(b) a step of the computer deriving reference mode information representing a mode shape serving as a reference for damage evaluation of the structure, using a structure model in which a value representing strength of a coupling rotation spring is set to represent a boundary condition of an intermediate support point of the structure; and

(c) a step of the computer calculating an index indicating a degree of similarity between the measured mode information and the reference mode information, and detecting damage to the structure based on the index indicating the degree of similarity.

### (Supplementary Note 8)

The damage detection method according to supplementary note 7,

wherein the structure model is represented using: coordinate functions that are used for representing amplitudes at positions corresponding to the sensors disposed at a plurality of locations of the structure; a boundary condition of the intermediate support point; and boundary conditions of both end support points respectively set at both end support points of the structure.

### (Supplementary Note 9)

The damage detection method according to supplementary note 7 or 8,

wherein, in the (b) step, the amplitudes at the positions of the sensors are derived by applying, to the structure model, distances between support points of the structure and a value representing strength of the coupling rotation spring.

### (Supplementary Note 10)

The damage detection method according to any one of supplementary notes 7 to 9,

wherein the vibration information is information representing displacement, information representing velocity, or information representing acceleration.

### (Supplementary Note 11)

The damage detection method according to any one of supplementary notes 7 to 10,

wherein, in the (c) step, the index representing the degree of similarity is calculated using a modal assurance criterion representing a correlation between the measured mode information and the reference mode information.

### (Supplementary Note 12)

The damage detection method according to any one of supplementary notes 7 to 11,

wherein the structure is a floor slab of a multi-span continuous bridge.

### (Supplementary Note 13)

A program that causes a computer to carry out:

(a) a step of extracting measured mode information representing a mode shape of a structure that is continuously supported at three or more support points, based on a plurality of pieces of vibration information measured by sensors that are disposed at a plurality of locations of the structure;

(b) a step of deriving reference mode information representing a mode shape serving as a reference for damage evaluation of the structure, using a structure model in which a value representing strength of a coupling rotation spring is set to represent a boundary condition of an intermediate support point of the structure; and

(c) a step of calculating an index indicating a degree of similarity between the measured mode information and the reference mode information, and detecting damage to the structure based on the index indicating the degree of similarity.

### (Supplementary Note 14)

The program according to Supplementary note 13,

wherein the structure model is represented using: coordinate functions that are used for representing amplitudes at positions corresponding to the sensors disposed at a plurality of locations of the structure; a boundary condition of the intermediate support point; and boundary conditions of both end support points respectively set at both end support points of the structure.

### (Supplementary Note 15)

The program according to Supplementary note 13 or 14,

wherein, in the (b) step, the amplitudes at the positions of the sensors are derived by applying, to the structure model, distances between support points of the structure and a value representing strength of the coupling rotation spring.

### (Supplementary Note 16)

The program according to any one of supplementary notes 13 to 15,

wherein the vibration information is information representing displacement, information representing velocity, or information representing acceleration.

### (Supplementary Note 17)

The program according to any one of supplementary notes 13 to 16,

wherein, in the (c) step, the index representing the degree of similarity is calculated using a modal assurance criterion representing a correlation between the measured mode information and the reference mode information.

### (Supplementary Note 18)

The program according to any one of supplementary notes 13 to 17,

wherein the structure is a floor slab of a multi-span continuous bridge.

As described above, according to the invention, it is possible to increase efficiency and accuracy in detecting damage to a structure that is continuously supported at three or more support points. The invention is useful in a field where damage detection of a structure is necessary.

While the invention has been particularly shown and described with reference to exemplary embodiments thereof, the invention is not limited to these embodiments. It will be understood by those of ordinary skill in the art that various changes in form and details may be made therein without departing from the spirit and scope of the invention as defined by the claims.

What is claimed is:

1. A damage detection apparatus comprising:
an extraction unit configured to extract measured mode information representing a mode shape of a structure that is continuously supported at three or more support points, based on a plurality of pieces of vibration information measured by sensors that are disposed at a plurality of locations of the structure;
a derivation unit configured to derive reference mode information representing a mode shape serving as a reference for damage evaluation of the structure, using a structure model in which a value representing strength of a coupling rotation spring is set to represent a boundary condition of an intermediate support point of the structure; and
a detection unit configured to calculate an index indicating a degree of similarity between the measured mode information and the reference mode information, and detect damage to the structure based on the index indicating the degree of similarity.

2. The damage detection apparatus according to claim 1,
wherein the structure model is represented using: coordinate functions that are used for representing amplitudes at positions corresponding to the sensors disposed at a plurality of locations of the structure; a boundary condition of the intermediate support point; and boundary conditions of both end support points respectively set at both end support points of the structure.

3. The damage detection apparatus according to claim 1,
wherein the derivation unit derives the amplitudes at the positions corresponding to the sensors by applying, to the structure model, distances between support points of the structure, and a value representing strength of the coupling rotation spring.

4. The damage detection apparatus according to claim 1,
wherein the vibration information is information representing displacement, information representing velocity, or information representing acceleration.

5. The damage detection apparatus according to claim 1,
wherein the detection unit calculates the index representing the degree of similarity using a modal assurance criterion representing a correlation between the measured mode information and the reference mode information.

6. The damage detection apparatus according to claim 1,
wherein the structure is a floor slab of a multi-span continuous bridge.

7. A damage detection method in which a computer carries out:
extracting measured mode information representing a mode shape of a structure that is continuously supported at three or more support points, based on a plurality of pieces of vibration information measured by sensors that are disposed at a plurality of locations of the structure;
deriving reference mode information representing a mode shape serving as a reference for damage evaluation of the structure, using a structure model in which a value representing strength of a coupling rotation spring is set to represent a boundary condition of an intermediate support point of the structure; and
calculating an index indicating a degree of similarity between the measured mode information and the reference mode information, and detecting damage to the structure based on the index indicating the degree of similarity.

8. A non-transitory computer-readable recording medium having recorded thereon a program including instructions for causing a computer to execute processes of:
extracting measured mode information representing a mode shape of a structure that is continuously supported at three or more support points, based on a plurality of pieces of vibration information measured by sensors that are disposed at a plurality of locations of the structure;
deriving reference mode information representing a mode shape serving as a reference for damage evaluation of the structure, using a structure model in which a value representing strength of a coupling rotation spring is set to represent a boundary condition of an intermediate support point of the structure; and
calculating an index indicating a degree of similarity between the measured mode information and the reference mode information, and detecting damage to the structure based on the index indicating the degree of similarity.
